(19) United States
(12) Patent Application Publication
(10) Pub. No.: US 2002/0083462 A1
(43) Pub. Date: Jun. 27, 2002

(54) Apparatus and method for establishing audio and video conferencing

(76) Inventor: Robert J. Arnott, Alpharetta, GA (US)

Correspondence Address: Hunton & Williams, 1900 K Street, N.W., Washington, DC, 20006-1109, US

(21) Appl. No.: 09/740,854

(22) Filed: Dec. 21, 2000

(51) Int. Cl. H04N 7/14

(52) U.S. Cl. 725/100; 348/14.08

(57) ABSTRACT

An apparatus, and method for establishing audio and video (visual) conferencing capabilities are disclosed. A communications device comprises a first interface to a first channel for transmitting and receiving voice over a voice network, such as the public switched telephone network (PSTN). The communications device further comprises a second interface to a second channel for transmitting and receiving video data. A connection to the second channel for transmitting and receiving video data is established upon receiving a pre-determined signal transmitted over the first channel from a second, similarly-configured communications device.

### FIELD OF THE INVENTION

The field of this invention relates generally to communications systems, and more particularly to an apparatus and method for establishing audio and video (visual) conferencing capabilities.

### BACKGROUND OF THE INVENTION

Three of the most common means by which audio and video (visual) conferencing capabilities are currently realized include stand-alone “room” systems, personal computer or PC-based Internet video systems, and individual video phone units.

Stand-alone videoconferencing “room” systems include those systems designed to allow an individual or plurality of people located in a designated space to be conferenced together with another individual or party at one time. These systems are most often utilized in the board rooms and meeting rooms of entities such as law firms, corporations, and universities, among other institutions. A substantial amount of audio and video hardware is necessary to support such systems, all of which can be expensive. In fact, it is not uncommon for some larger videoconferencing systems to comprise several video cameras, television monitors or displays, microphones, and speakers. In addition, several ISDN (integrated services digital network) channels are often required to effectively communicate the voice and video data. The expense associated with operating and maintaining these stand-alone videoconferencing systems often serves as a barrier to smaller entities. In addition, these systems may be impractical for personal use in the home.

PC-based Internet video systems have represented a recent trend in audio and video conferencing. Through the use of commercial videoconferencing software, users have been able to configure their personal computers to combine Internet telephony with video capability, allowing them to participate in real-time conversations over the Internet. This is especially attractive to some computer users, as they may avoid paying long distance telephone charges for calls made nationwide, or even worldwide. Rather, users only have to pay their usual internet access fee charged by their Internet service provider. While PC-based Internet video systems do provide individual videoconferencing via a personal computer, numerous drawbacks exist. One of the most formidable challenges associated with PC-based Internet video systems is getting the videoconferencing software to work with a user's hardware set-up.

In order to run videoconferencing software properly, a user may have to invest in a sound card, speakers, and microphone, as well as a web camera, and a capture video card. Most videoconferencing software packages also establish minimum RAM (random access memory) requirements for PCs hosting the software in order to support video transmission. If a user is able to successfully configure their PC to support the videoconferencing software, they may find that they can only establish videoconferencing sessions with other users running the same videoconferencing software on their machines. Unfortunately, the exclusive nature of some videoconferencing software producers prevents their consumers from establishing videoconferencing sessions with users running competing software.

In addition, while PC-based Internet video systems represent a movement toward more personal video conferencing systems, they may not be practical for everyone. For example, it may unreasonable to expect people without a computer to spend thousands of dollars on a computer, the videoconferencing software, any additional necessary hardware, and Internet connection fees so that they can make video phone calls. In addition to the costs, PC-based Internet video systems may not be embraced by individuals who are not computer literate, yet still desire to make video phone calls.

An alternative to expensive “room” systems, and PC-based systems exists in the form of individual video phones designed to work over the public switched telephone network (PSTN). Such phones typically comprise an integral camera and video display, and are ready to use simply by plugging into a standard phone jack. These video phones may be difficult to find in the marketplace, however, and tend to have significant cost. In addition, a video phone call may only be established if both parties to a call have a video phone. These and other drawbacks exist.

A need therefore exists for a communications device that can provide audio and video (visual) conferencing capabilities to users regardless of computer literacy, and without excessive cost.

### SUMMARY OF THE INVENTION

The invention solving these and other problems in the art relates to an apparatus and method by which a communications device may connect to other terminals via dual voice network and data connections, and be used to deliver effective videoconferencing services.

A communications device (or video phone appliance), according to the invention, may include conventional telephone components, as well as a charge coupled device (CCD) camera for capturing video of an individual using the video phone appliance, and a liquid crystal display (LCD) for viewing a party using a second video phone appliance. In addition, a first connection may interface to each video phone appliance to provide a first channel for transmitting voice data to another party via a voice network such as, for example, the public switched telephone network (PSTN). A second connection may interface to each video phone appliance to provide a second channel for transmitting video data. The second connection to the video phone may be, include, or interface to a data connection, such as a digital subscriber line (xDSL), an Ethernet connection, a synchronous optical network (SONET) connection, a digital T1, T3, E1 or E3 line, or an Integrated Services Digital Network (ISDN) line, to name just a few.

When a caller using a first video phone appliance wishes to establish a video phone call with a callee using a second video phone appliance, he or she may dial the telephone number of the callee, as if placing an ordinary call. When the callee answers the phone, a voice path between the caller and callee is established via the voice network (e.g.—PSTN), as is known in the art. If the callee answers the call using a video phone appliance of a type compatible with the invention, a short tone burst may be transmitted from the callee's video phone appliance to the caller's video phone appliance in the voice frequency band of the established voice path. The short tone burst may include a sequence of characters or other data, one portion of which may include the IP (Internet Protocol) address of the callee. Each video phone appliance may be configured to digitize and decode incoming tone bursts. Accordingly, the video phone appliance of the caller may extract the IP address of the callee from the tone burst, and use it to establish a data connection to the callee via an xDSL line or other link so that video captured using the respective CCD cameras may be transmitted. The voice conversation proceeds over the voice path, and the video transmission occurs via the data connection.

If a call placed using a video phone appliance is answered by an individual with a standard telephone, a tone burst may not be transmitted as standard telephones are typically not configured to make special purpose transmissions. In such an instance, in the absence of a video connection, the LCD of the video phone appliance of the caller may simply be blank, or display advertisements. Advertisers may pay the local phone company to transmit these advertisements down to the phone in order to subsidize the cost of the data connection.

One advantage of the invention is that any configuration necessary to establish a video phone call may be stored with the video phone appliance itself. The PSTN has been in existence as a voice network for decades, and data technologies such as xDSL are readily available and accessible. No new networking protocol issues are raised. A video phone appliance is instead based on a camera, a display, a first connection to a voice network (e.g.—PSTN), and a second connection via an xDSL or other data connection.

Another advantage of the invention lies in the fact that no PC knowledge is required. There is no need to purchase a computer, as well as the necessary hardware and software needed to establish personal videoconferencing services.

Internet (or intranet) access may be required, however, to provide video. If a user already has existing access to the Internet via an xDSL modem, an additional connection to the 10BaseT Ethernet port on the xDSL modem may be required. Alternatively, in an embodiment of the invention, an Ethernet port may provided on the video phone appliance allowing a user to utilize an xDSL modem provided with the video phone appliance. Conversely, if a user does not have an existing internet service plan, access may be provided as part of the video phone appliance service.

These and other objects, features and advantages of the invention will be apparent through the detailed description of the preferred embodiments and the drawings attached hereto. It is also to be understood that both the foregoing general description and the following detailed description are exemplary and explanatory and not restrictive of the scope of the invention.

### BRIEF DESCRIPTION OF THE DRAWINGS

The invention will be described with respect to the accompanying drawings, in which like elements are referenced with like numbers.

FIG. 1 illustrates a communications device that may be used in the system and method of providing videoconferencing services, according to an embodiment of the invention.

FIG. 2 is a schematic diagram of a system for providing videoconferencing services, according to an embodiment of the invention.

FIG. 3 illustrates a message character format of a tone burst, according to an embodiment of the invention.

FIG. 4 illustrates a schematic diagram of a system for providing videoconferencing services, according to an embodiment of the invention.

FIG. 5 illustrates a flowchart of processing according to the invention, in one regard.

### DETAILED DESCRIPTION OF THE PREFERRED EMBODIMENTS

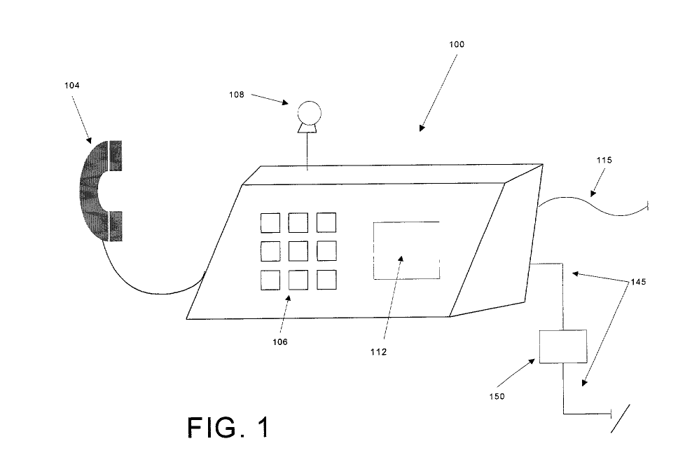

FIG. 1 illustrates a video phone appliance 100 which is configured for use according to an embodiment of the invention. The video phone appliance 100 may include conventional components such as a handset 104 (or speakerphone) for facilitating voice communication, as well as an array of touch-tone keys 106 for dialing. Any additional, standard features, such as pre-programmable phone number storage, may also be provided.

In order to provide video transmission services, the video phone appliance 100 may include additional components. A charge coupled device (CCD) camera 108, for example, may be provided to capture video of an individual using the video phone. The CCD camera 108 may be integral with the body of the video phone appliance 100, or detachable, to afford a user the freedom to position the camera as desired. A liquid crystal display (LCD) 112 may also be provided with the video phone appliance 100, so that a user may view a party speaking to them via a second video phone appliance. Although LCD 112 is illustrated in FIG. 1 as being integral with the body of the video phone appliance 100, it may also be detachable from the body of the video phone appliance 100, allowing a user to position it for optimal viewing.

A first connection 115 interfaces to the video phone appliance 100 to provide a first channel for transmitting voice data to another party via a voice network such as the public switched telephone network (PSTN), as is understood by persons skilled in the art.

A second connection 145 interfaces to the video phone appliance 100 in order to provide a second channel for transmitting video data. The second connection 145 to the video phone appliance may be, include, or interface to a digital subscriber line (xDSL), an Ethernet connection, a synchronous optical network (SONET) connection, a digital T1, T3, E1 or E3 line, or an Integrated Services Digital Network (ISDN) line, to name just a few.

In the embodiment illustrated in FIG. 1, the second connection 145 depicts an xDSL line. Accordingly, an xDSL modem 150 is also illustrated. Digital subscriber lines or xDSL technologies use modulation schemes to pack data on to copper wires of the local telephone loop. It should be recognized that the invention may utilize various types of digital subscriber lines, including symmetric digital subscriber lines (SDSL), high-data-rate digital subscriber lines (HDSL), and voice-over digital subscriber lines (VoDSL) for the transmission of video data.

Additionally, an asymmetric digital subscriber line (ADSL) may be used, as well as G.Lite. Both ADSL and G.Lite allow more data to be sent over existing copper telephone lines at greater speeds in the downstream direction. In addition, ADSL and G.Lite allow for the use of one connection for the transmission of both voice and video data. Accordingly, although the first connection 115 and second connection 145 are illustrated separately in FIG. 1, those skilled in the art will realize that they may be one in the same when ADSL or G.Lite is used.

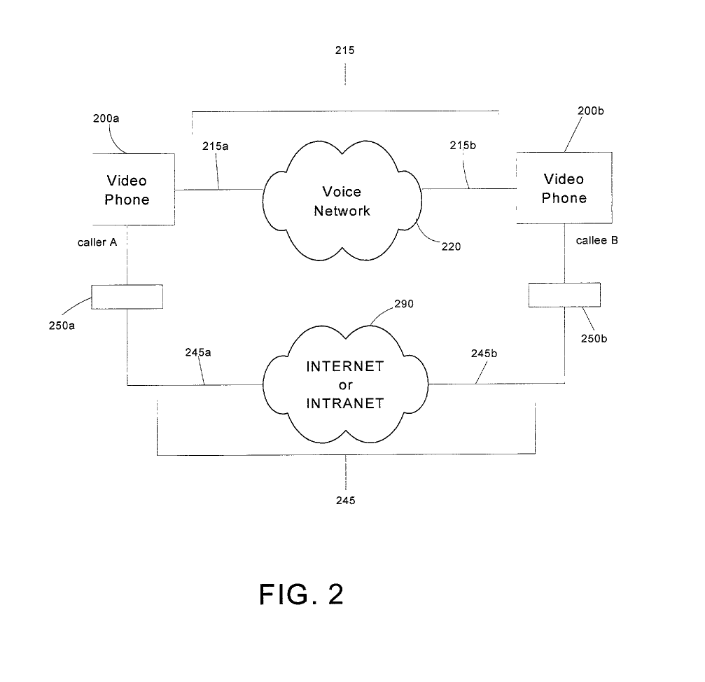

The video phone appliance 100, as described above in reference to FIG. 1, may be operated in the context of an environment illustrated in FIG. 2. Although any number of video phone appliances 100 may be deployed in the system, two video phone appliances, labeled 200a and 200b respectively, are shown for ease of illustration. Further, for purposes of explanation, video phone appliances 200a and 200b are assumed to be located in separate subscriber residences.

Video phone appliance 200a includes a voice channel 215a that provides a first interface to a voice network 220, such as the PSTN. A second connection 245a provides a second interface to the Internet 290 or other network for video transmission.

Likewise, video phone appliance 200b includes a voice channel 215b for providing a first interface to the voice network 220, as well as a connection 245b for interfacing to the Internet 290 or other network for video transmission.

The respective connections (245a, 245b) for video transmission may be, include, or interface to a digital subscriber line (xDSL), an Ethernet connection, a synchronous optical network (SONET) connection, a digital T1, T3, E1 or E3 line, or an Integrated Services Digital Network (ISDN) line, to name just a few. When an xDSL is chosen to provide video transmission, xDSL modems (250a, 250b) may be required, as illustrated in FIG. 2.

When a caller A using video phone appliance 200a seeks to establish a video phone call with a callee B using video phone appliance 200b, he or she may dial the telephone number of the callee B, as if placing an ordinary phone call. When the callee B answers the phone, a voice path 215 between the caller A and callee B is established via a voice path such as the PSTN, as is known in the art. When the callee B answers the call on video phone appliance 200b, a short tone burst may be transmitted in the voice frequency band of the voice path 215 back to the caller A. The tone burst is configured such that it may be passed in the voice frequency band of the voice path 215, allowing it to be carried end to end through the voice network. Each video phone appliance (200a, 200b) may be configured to transmit such a tone burst when a user answers a call.

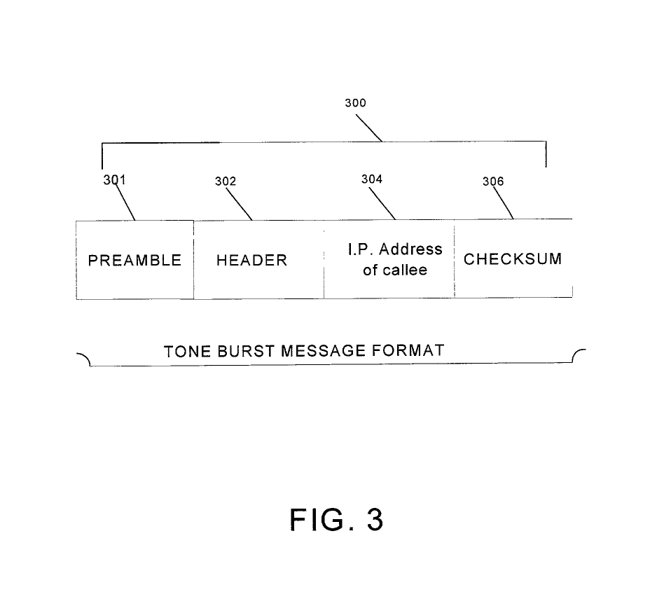

An illustration of a tone burst 300 is described in reference to FIG. 3. A tone burst 300 transmitted by the video phone appliance of the callee B to the caller A may include a sequence of characters or data in other formats. The first field 301 of tone burst 300 may comprise a preamble or repeating sequence of characters that would allow the video phone appliance 200a of caller A to synchronize to the tone burst so that it is prepared to receive the data from the video phone appliance 200b of callee B.

The second field 302 of tone burst 300 may contain “header” information to identify the phone which has answered the call as a video phone appliance.

The third field 304 of tone burst 300 may include the IP (Internet Protocol) address of the callee B, thus enabling the video phone appliance 200a of caller A to establish a video connection with the video phone appliance 200b of callee B via their respective xDSL or other data connections. Existing IP addresses may vary in size. Some IP addresses may be 32 bits long, requiring 4 bytes, while others may be 128 bits in length, requiring 16 bytes. Accordingly, the third field 304 of tone burst 300 may also vary in size to accomodate the number of bytes necessary to convey the IP address of the video phone appliance 200b of callee B to the video phone appliance 200a of the caller A.

A fourth field 306 may comprise a checksum character as an error detection mechanism used to ensure that the message was received correctly. The checksum character may reflect a numerical value that is based on the number of 1's present in the bits of the message. If the numerical value tabulated when the message is sent does not equal the numerical value when the message is received, it may be assumed that the message was scrambled. Other data sequences within tone burst 300 are possible.

The tone burst, which may be audible to both the caller A and callee B, may be captured and decoded by the video phone appliance 200a of the caller A. Each video phone appliance (200a, 200b) may include an analog modem (not shown) to receive the tone burst, as is currently used for data communications in the voice band. Training algorithms may not be required since the amount of information being passed in the tone burst is minimal, and reliability and simplicity over speed is desirable. A band-pass filter (not shown) may also be configured to pass or detect the tone burst, while excluding any unused frequencies. Similarly, each video phone appliance may contain an analog to digital converter (not shown) to digitize the tone burst so that it may be decoded and separated into its respective fields or other characters. Any known conversion or sampling techniques may be used. Pulse code modulation (PCM), for example, is a sampling technique for digitizing analog signals, especially audio signals. Accordingly, each video phone appliance (200a, 200b) may include a PCM or other decoder.

Once the tone burst 300 has been digitized, and separated into its constituent fields, illustratively (301, 302, 304, 306), the video phone appliance 200a of the caller A may be auto-configured to establish an xDSL or other data connection 245 to the video phone appliance 200b of callee B. This may be done by capture of the IP address of the callee B that was transmitted by the caller A in the third field 304 of tone burst 300. The voice conversation then proceeds over the voice path 215, while the video captured using the respective CCD cameras may be transmitted via the xDSL or other data connection 245 to the LCD displays on the respective video phones.

At the termination of a call, the phone call is ended as normal, with either party hanging up the phone. When either video phone appliance (200a, 200b) is hung up, video transmission to the opposite video phone appliance may cease, leaving the LCD display blank. Alternatively, a connection may automatically be established to a web location where advertisements are displayed. Advertisers may pay the local phone company to push these advertisements down to the phone in order to subsidize the cost of the xDSL, if an xDSL is being used. If a video phone appliance user is interested in specific information (e.g.—weather, sports, stock prices, etc.) they could pay an additional fee to effectively block those advertisements which he or she is not interested in. These advertisements would be displayed on the LCD of the caller's video phone. It should be recognized that the LCD may be left blank or filled with advertisements both when the video phone appliance is not in use, or when a call placed with the video phone appliance is answered by a standard telephone.

In an embodiment of the invention, a user may be able to input the IP (internet protocol address) of a default Internet web page to be displayed whenever the phone is not in use, or when a call placed with the video phone appliance is answered by a standard telephone.

When a call is terminated, a slight delay may occur before video transmission is terminated. This delay is to avoid dropping the video connection in the case of a hook flash which is used for some phone services, such as call-waiting or three-way calling.

In an embodiment of the invention, multiple video streams may be displayed on the LCD display simultaneously, or a user may select from different video streams to be displayed during the course of a call. Such a feature may be advantageous in a three-way call in which a user then has the ability to view each of the individuals with whom he or she is engaged in a video conferencing session. Such a feature may also be advantageous when one party to a video phone call may, perhaps, notify a second party to the video phone call as to the existence of an interesting live web-cast, web page, or other on-line event. Both parties may then have the ability to choose between displaying the image of the other party to the call, or displaying the on-line event or web page of interest, or both.

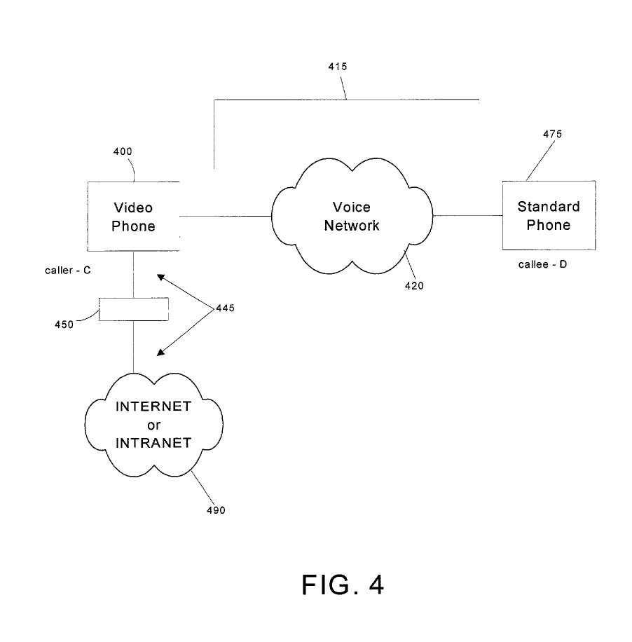

FIG. 4 illustrates an embodiment of the invention that may occur when a call placed using a video phone appliance 400 is answered by a user with a standard telephone 475. Caller C is shown having a digital subscriber line 445 that provides an interface to the Internet 490 via a DSL modem 450 for video transmission. Other data connections may be used. If a caller C using a video phone appliance 400 wishes to place a call to a callee D using a standard telephone 475, he or she may dial the telephone number of the callee D, as if placing an ordinary phone call. When the callee D answers the phone, a voice path 415 between the caller C and callee D may be established via a voice network such as the PSTN, as is known in the art. Since the callee D has answered the call on a standard telephone 475, a tone burst as previously described may not be transmitted, as standard telephones are typically not configured to make such a transmission. In such an instance, as previously described, the LCD of the caller's video phone may simply be blank, or may display advertisements.

As described above, a short tone burst may be transmitted in the voice frequency band of the voice path from the video phone appliance of the callee to the video phone appliance of the caller. This tone burst may present a source of irritation to some users. Accordingly, in an embodiment of the invention, video phone appliances which are configured according to the invention may not be auto-configured to transmit a tone burst upon answering a call. Rather, the plurality of fields or other data characters may be transmitted from the video phone appliance of a caller to the video phone appliance of a callee between ringing cycles, similar to “Caller I.D.”

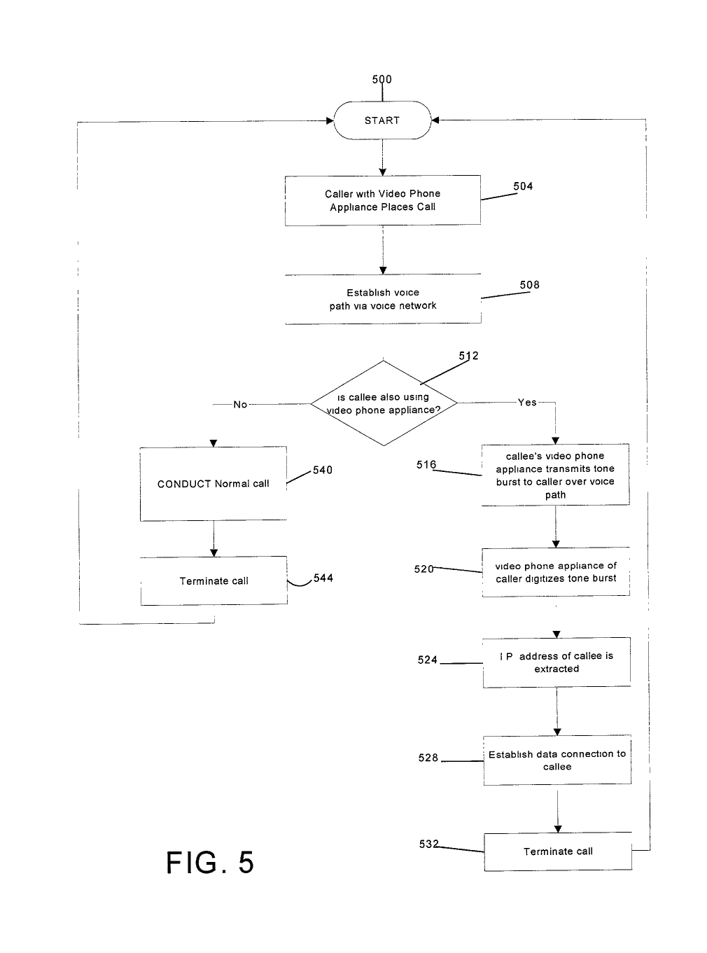

FIG. 5 illustrates a flowchart of processing according to the invention, in one regard. Processing begins at start 500. In step 504, a user with a video phone appliance (hereinafter referred to as the caller) places a phone call. When the call is answered by a callee in step 508, a voice path is established via a voice network such as the PSTN, as is known in the art. In step 512, a determination is made as to whether or not the callee answered the phone call using a video phone appliance. If the callee answers the call using a video phone appliance, a short tone burst may be transmitted from the video phone appliance of the callee to the video phone appliance of the caller in step 516. The tone burst is transmitted in the voice frequency band of the voice path. Each video phone appliance may be configured to automatically transmit such a tone burst when a user answers a call.

The tone burst transmitted in step 516 may include a sequence of data fields or other characters. The first field of the tone burst may comprise a preamble or repeating sequence of characters that would allow the video phone appliance of the caller to synchronize to the tone burst so that it is prepared to receive the data from the video phone appliance of the callee.

The second field of the tone burst may contain information to identify the phone which has answered the call as a video phone appliance. The third field of the tone burst may contain the IP (Internet Protocol) address of the callee, which may thus enable the video phone appliance of the caller to establish a video connection with the video phone appliance of the callee. The video connection may occur via their respective xDSL or other data connections. A fourth field may comprise a checksum character that may constitute the last field of the tone burst. That, or other detection mechanisms may be used to ensure that the message was received correctly.

Once the tone burst has been digitized in step 520, and separated into its respective fields, the video phone appliance of the caller may, in step 524, extract the IP address of the callee that was transmitted in the third field of the tone burst. The video phone appliance of the caller may then establish a connection via an xDSL or other link to the video phone appliance of the callee using the IP address of the callee, as is illustrated in step 528.

At this point, the voice conversation may proceed over the voice path that was established in step 508, while the video captured using the respective CCD cameras of the two video phone appliances may be transmitted via the xDSL or other data connection established in step 528. The video data will be transmitted to the LCD displays of the respective video phones.

At the termination of a call, in step 532, the phone call is ended as normal, with either party hanging up the phone. When either video phone appliance is hung up, video transmission to the opposite video phone appliance may cease, leaving the LCD display blank. Alternatively, a connection may automatically be established to a web location where advertisements are displayed. When a call is terminated, a slight delay may occur before video transmission is terminated. This delay is to avoid dropping the video connection in the case of a hook flash which is used for some phone services, such as call-waiting or three-way calling.

Referring to step 512, a callee may answer the call using a standard telephone. In such an instance, a tone burst as previously described may not be transmitted, as standard telephones are typically not configured to make such a transmission. Accordingly, a normal phone call without video transmission may occur in step 540, until either party terminates the phone call in step 544.

Other embodiments, uses and advantages of the invention will be apparent to those skilled in the art from consideration of the specification and practice of the invention disclosed herein. The specification should be considered exemplary only, and the scope of the invention is accordingly intended to be limited only to the following claims.

What is claimed is:

1. A communications device, comprising:
a first interface to a first channel for transmitting and receiving voice over a voice network;
a second interface to a second channel for transmitting and receiving video data;
wherein the communications device is configured to establish a connection to at least the second channel for videoconferencing upon receiving a pre-determined signal over the first channel.

2. The communications device of claim 1, wherein the first channel is the public switched telephone network (PSTN).

3. The communications device of claim 1, wherein the second channel comprises a data connection.

4. The communications device of claim 3, wherein the data connection comprises at least one of an asymmetric digital subscriber line (ADSL), a symmetric digital subscriber line (SDSL), a high-data-rate digital subscriber line (HDSL), or a voice-over digital subscriber line (VoDSL).

5. The communications device of claim 4, wherein the data connection further comprises a digital subscriber line (DSL) modem.

6. The communications device of claim 1, wherein the video data transmitted via the second channel is captured using a charge coupled device camera (CCD) configured for use with the communications device.

7. The communications device of claim 6, wherein the charge coupled device (CCD) camera is integral with the communications device.

8. The communications device of claim 6, wherein the charge coupled device (CCD) camera is separable from the communications device.

9. The communications device of claim 1, wherein the video data received via the second channel is displayed using a liquid crystal display (LCD) configured for use with the communications device.

10. The communications device of claim 9, wherein the liquid crystal display (LCD) is integral with the communications device.

11. The communications device of claim 9, wherein the liquid crystal display (LCD) is separable from the communications device.

12. The communications device of claim 9, wherein the liquid crystal display (LCD) is used to display advertisements transmitted via the second channel, when the first channel is not transmitting or receiving voice.

13. The communications device of claim 1, wherein the predetermined signal is a tone burst comprising a sequence of data that is transmitted from a second communications device.

14. The communications device of claim 13, wherein the sequence of data comprises a first field, the first field comprising a repeating sequence of characters allowing the communications device to synchronize to the tone burst.

15. The communications device of claim 14, wherein the sequence of data comprises a second field, the second field comprising header information to identify the second communications device as being a similarly-configured communications device.

16. The communications device of claim 15, wherein the sequence of data comprises a third field, the third field comprising an Internet protocol (IP) address of the second communications device.

17. The communications device of claim 16, wherein the sequence of data comprises a fourth field, the fourth field comprising a checksum character that serves as an error detection mechanism to ensure that the tone burst was transmitted correctly.

18. The communications device of claim 17, further comprising an analog modem to receive the tone burst.

19. The communications device of claim 18, further comprising a filter to pass the tone burst while excluding any unused frequencies.

20. The communications device of claim 19, further comprising an analog to digital converter configured to digitize the tone burst.

21. The communications device of claim 20, wherein the analog to digital converter is a pulse code modulation (PCM) decoder.

22. The communications device of claim 20, wherein the Internet Protocol (IP) address of the second communications device is extracted from the digitized tone burst and used to establish the second channel for videoconferencing.

23. A communications device, comprising:
an interface to a first and second channel;
wherein the first channel is for transmitting and receiving voice over a voice network;
wherein the second channel is for transmitting and receiving video data;
wherein the communications device is configured to establish a connection to at least the second channel for videoconferencing upon receiving a pre-determined signal over the first channel.

24. A method for establishing a video conferencing session, comprising the steps of:
a) providing a first interface to a first channel for transmitting and receiving voice over a voice network;
b) providing a second interface to a second channel for transmitting and receiving video data; and
c) establishing a connection to at least the second channel for videoconferencing upon receiving a predetermined signal over the first channel.
